(19) United States
(12) Patent Application Publication
(10) Pub. No.: US 2023/0041527 A1
(43) Pub. Date: Feb. 9, 2023

(54) INFORMATION PROCESSING APPARATUS THAT CALCULATES USE PRIORITY WITH RESPECT TO PLURALITY OF IMAGE FORMING APPARATUSES, AND TRANSMITS PRINT JOB TO IMAGE FORMING APPARATUS OF HIGHEST PRIORITY, AND PRINT CONTROL METHOD

(71) Applicant: KYOCERA Document Solutions Inc., Osaka (JP)

(72) Inventors: Carl Christian Ray PANTIN, Osaka (JP); Deniel MOLINA, Osaka (JP); Icel Ann RODRIGUEZ, Osaka (JP); Jesus Jovannie John BURGOS, Osaka (JP); John James GUTIB, Osaka (JP); John Mathew CABIDO, Osaka (JP); Matthew GRAFILO, Osaka (JP); Melvin GAVIOLA, JR., Osaka (JP); Nixon SEGARRA, JR., Osaka (JP); Rodney OMANGAYON, Osaka (JP); Shiela Mae QUIMBO, Osaka (JP)

(73) Assignee: KYOCERA Document Solutions Inc., Osaka (JP)

(21) Appl. No.: 17/874,961

(22) Filed: Jul. 27, 2022

(30) Foreign Application Priority Data
Aug. 5, 2021 (JP) 2021-129235

(51) Int. Cl. G06F 3/12

(52) U.S. Cl. CPC G06F 3/1263; G06F 3/1285

(57) ABSTRACT

An information processing apparatus includes an operation device, a communication device, and a control device. The operation device receives an instruction according to an operation performed by a user. The communication device performs data communication with a plurality of image forming apparatuses. The control device acts as a calculator and a controller. The calculator calculates an evaluation value for each of one or more evaluation items designated by the user through the operation device and calculates a sum of the calculated evaluation values, as use priority, with respect to each of the plurality of image forming apparatuses. The controller transmits a print job, execution of which has been instructed by the user through the operation device, to the image forming apparatus that has gained highest user priority, via the communication device.

### INCORPORATION BY REFERENCE

This application claims priority to Japanese Patent Application No. 2021-129235 filed on Aug. 5, 2021, the entire contents of which are incorporated by reference herein.

### BACKGROUND

The present disclosure relates to an information processing apparatus, such as a personal computer (PC), that performs data communication with a plurality of image forming apparatuses, and to a print control method.

A plurality of multifunction peripherals, or image forming apparatuses such as a printer, are often installed in an office or the like. When the users are free to utilize any of the plurality of image forming apparatuses, the users may sometimes find it difficult to determine which of the image forming apparatuses to use, to efficiently execute a print job.

In this relation, a first technique to determine the printer to be used for the print job, on the basis of the time it takes before the print job is completed, is generally known. In addition, a second technique to cause a first printer, instructed to execute the print job, to transfer the print job to a second printer, when the first printer decides that the print job is unable to be executed, is also known. Further, a third technique to select the printer that completes the print job in a shortest time, on the basis of the print speed, is known.

### SUMMARY

The disclosure proposes further improvement of the foregoing techniques.

In an aspect, the disclosure provides an information processing apparatus including an operation device, a communication device, and a control device. The operation device receives an instruction according to an operation performed by a user. The communication device performs data communication with a plurality of image forming apparatuses. The control device includes a processor, and acts as a calculator and a controller, when the processor executes a control program. The calculator calculates an evaluation value for each of one or more evaluation items designated by the user through the operation device and calculates a sum of the calculated evaluation values, as use priority, with respect to each of the plurality of image forming apparatuses. The controller transmits a print job, execution of which has been instructed by the user through the operation device, to the image forming apparatus that has gained highest user priority, via the communication device.

In another aspect, the disclosure provides a print control method to be executed by an information processing apparatus including an operation device and a communication device. The operation device receives an instruction according to an operation performed by a user. The communication device performs data communication with a plurality of image forming apparatuses. The print control method includes calculating an evaluation value for each of one or more evaluation items designated by the user through the operation device and calculating a sum of the calculated evaluation values, as use priority, with respect to each of the plurality of image forming apparatuses, and transmitting a print job, execution of which has been instructed by the user through the operation device, to the image forming apparatus that has gained highest user priority, via the communication device.

### BRIEF DESCRIPTION OF THE DRAWINGS

FIG. 1 is a schematic diagram showing a general configuration of a print control system including an information processing apparatus, according to an embodiment of the disclosure;

FIG. 2 is a functional block diagram schematically showing an essential internal configuration of an image forming apparatus;

FIG. 3 is a functional block diagram schematically showing an essential internal configuration of an information processing apparatus;

FIG. 4 is a schematic drawing showing an example of a data structure in an apparatus information storage region;

FIG. 5A and FIG. 5B are schematic diagrams each showing an example of a map, created by mapping an entire office where the image forming apparatus is installed, on a two-dimensional plane;

FIG. 6 is a schematic drawing showing an example of an operation screen;

FIG. 7 is a schematic drawing showing another example of the operation screen;

FIG. 8 is a schematic diagrams each showing an example of a map, created by mapping an entire office where the information processing apparatus is installed, on a two-dimensional plane;

FIG. 9A and FIG. 9B each represent an equation to be used for calculation of an evaluation value, with respect to each of evaluation items; and

FIG. 10 is a flowchart showing an example of a priority calculation process.

### DETAILED DESCRIPTION

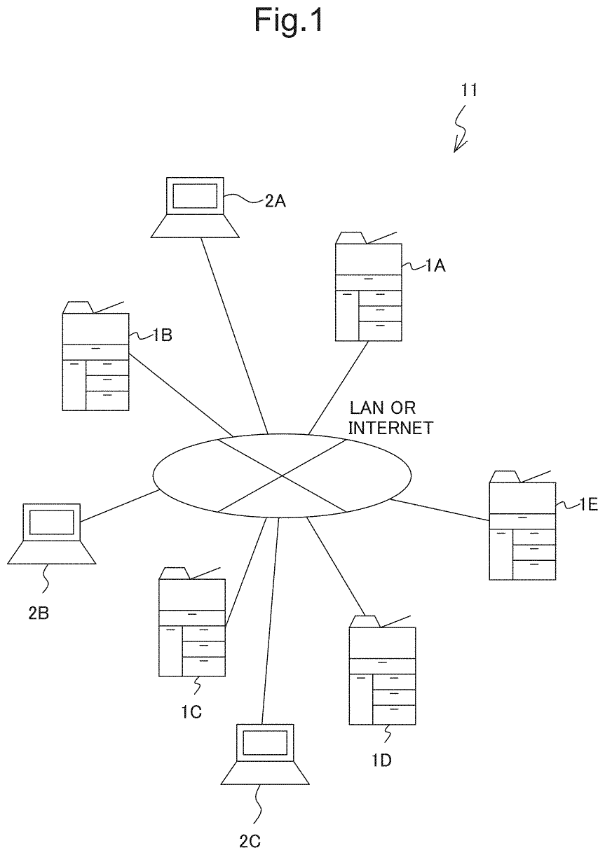

Hereafter, an information processing apparatus and a print control method according to an embodiment of the disclosure will be described, with reference to the drawings. FIG. 1 is a schematic diagram showing a general configuration of the print control system 11 including the information processing apparatuses 2A to 2C, according to the embodiment of the disclosure.

The print control system 11 includes a plurality of image forming apparatuses 1A to 1E (hereinafter collectively referred to as “image forming apparatus 1”, where appropriate), and a plurality of information processing apparatuses 2A to 2C (hereinafter collectively referred to as “information processing apparatus 2”, where appropriate), located on a network such as the internet. The image forming apparatuses 1A to 1E and the information processing apparatuses 2A to 2C are configured to communicate with one another, via the network.

The image forming apparatus 1 is a multifunction peripheral having a plurality of functions, such as copying, printing, scanning, and facsimile transmission. The information processing apparatus 2 is, for example, a PC. The information processing apparatus 2 is configured to create a print job, and transmit the created print job to the image forming apparatus 1.

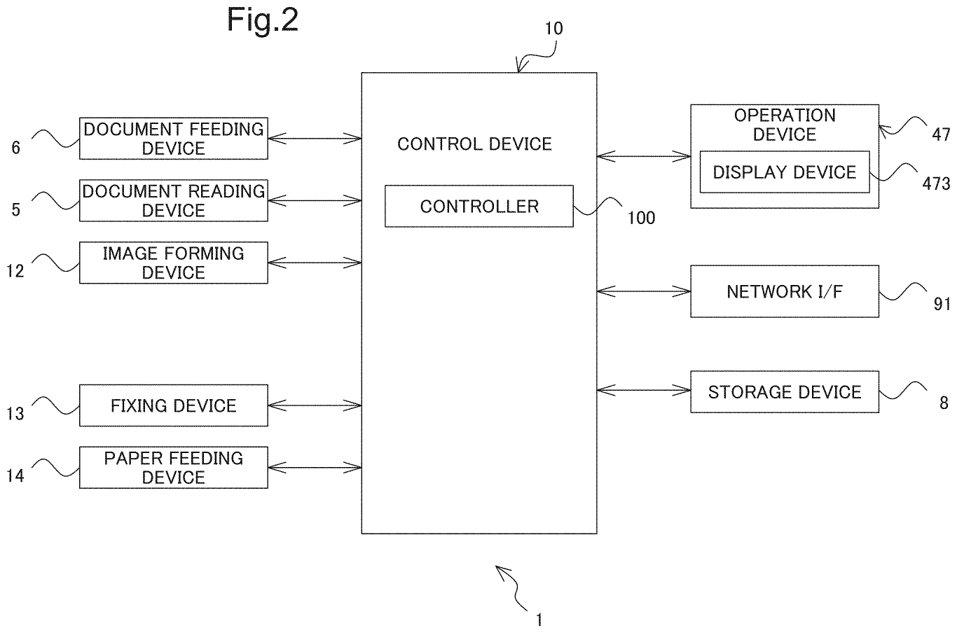

FIG. 2 is a functional block diagram schematically showing an essential internal configuration of the image forming apparatus 1. The image forming apparatus 1 includes a control device 10, a document feeding device 6, a document reading device 5, an image forming device 12, a fixing device 13, a paper feeding device 14, an operation device 47, a network interface (I/F) 91, and a storage device 8.

The document feeding device 6 is openably connected to the upper face of the document reading device 5, for example via a hinge. The document feeding device 6 serves as a document retention cover, when the document reading device 5 reads a source document placed on the platen glass. The document feeding device 6 is configured as an automatic document feeder (ADF). The document feeding device 6 includes a document tray, and delivers the source documents placed thereon one by one, to the document reading device 5.

To perform the document reading operation, the image forming apparatus 1 operates as follows. The document reading device 5 optically reads the image on the source document delivered from the document feeding device 6 to the document reading device 5, or placed on the platen glass, and generates image data. The image data generated by the document reading device 5 is stored, for example, in an image memory

To perform the image forming operation, the image forming apparatus 1 operates as follows. The image forming device 12 forms a toner image on a recording sheet, serving as a recording medium, delivered from the paper feeding device 14, on the basis of the image data generated through the document reading operation, or image data received from a computer (e.g., information processing apparatus 2), acting as an external device connected via a network.

The fixing device 13 heats and presses the recording sheet on which the toner image has been formed by the image forming device 12, to thereby fix the toner image on the recording sheet. The recording sheet that has undergone the fixing process is delivered to an output tray. The paper feeding device 14 includes a paper cassette.

The storage device 8 is a large-capacity storage device such as a hard disk drive (HDD) and a solid-state drive (SSD). The storage device 8 contains various control programs

The operation device 47 includes hard keys. The operation device 47 receives instructions from the user to execute the functions and operations that the image forming apparatus 1 is configured to perform (e.g., instruction to execute the printing operation), according to the user's operation performed on the hard key. The operation device 47 includes a display device 473 for displaying, for example, an operation guide for the user. The operation device 47 receives, through a touch panel provided on the display device 473, the user's instruction based on the touch operation performed by the user on the operation screen displayed on the display device 473, or on the hard key.

The display device 473 includes, for example, a liquid crystal display (LCD). The display device 473 includes the touch panel. When the user touches a button or a key displayed on the screen, the touch panel detects the instruction corresponding to the touched position.

The network I/F 91 is a communication interface that transmits and receives various types of data to and from an external device inside a local area, or on the internet (e.g., information processing apparatus 2).

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU).

The control device 10 acts as a controller 100, when the processor operates according to a control program stored in the storage device 8. Here, the controller 100 may be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the fixing device 13, the paper feeding device 14, the operation device 47, the network I/F 91, and the storage device 8, and controls the operation of the mentioned components. For example, the controller 100 controls the image forming device 12 and the related components so as to form an image on the recording sheet, on the basis of the print job received from the information processing apparatus 2 via the network, thereby creating a printed material.

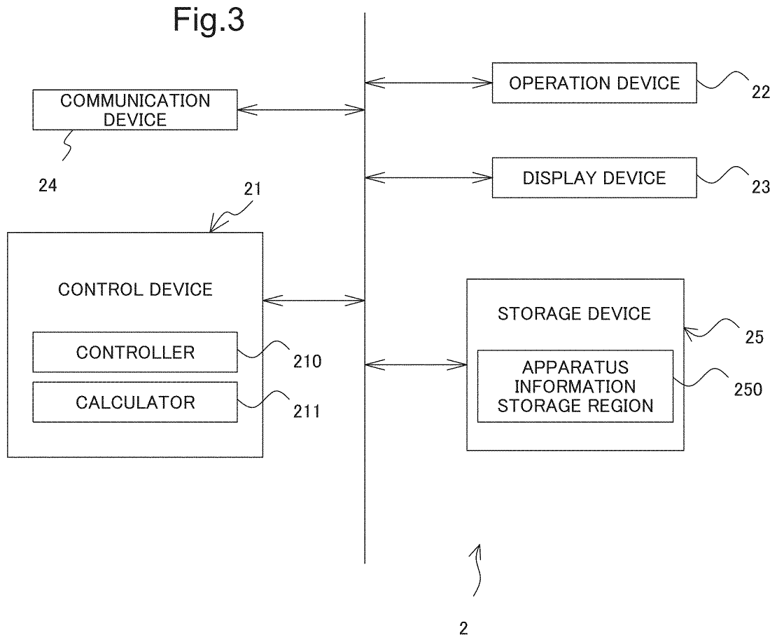

FIG. 3 is a functional block diagram schematically showing an essential internal configuration of the information processing apparatus 2. The information processing apparatus 2 includes a control device 21, an operation device 22, a display device 23, a communication device 24, and a storage device 25. These components can transmit and receive data and signals to and from each other, via a communication path.

The operation device 22 includes a keyboard, a mouse, and so forth. The operation device 22 outputs a command or characters to a controller 210 to be subsequently described. The operation device 22 receives the input of the user's instruction according to the operation performed thereon by the user. The display device 23 includes, for example, an LCD. The display device 23 displays a response from the control device 21, or retrieved data.

The communication device 24 is a communication interface that transmits and receives various types of data to and from external devices inside a local area or on the internet, such as the image forming apparatus 1.

The storage device 25 is a large-capacity storage device such as an HDD or an SSD. The storage device 25 contains various control programs The storage device 25 includes an apparatus information storage region 250, for storing the apparatus information of each of the image forming apparatuses 1A to 1E connected via the network.

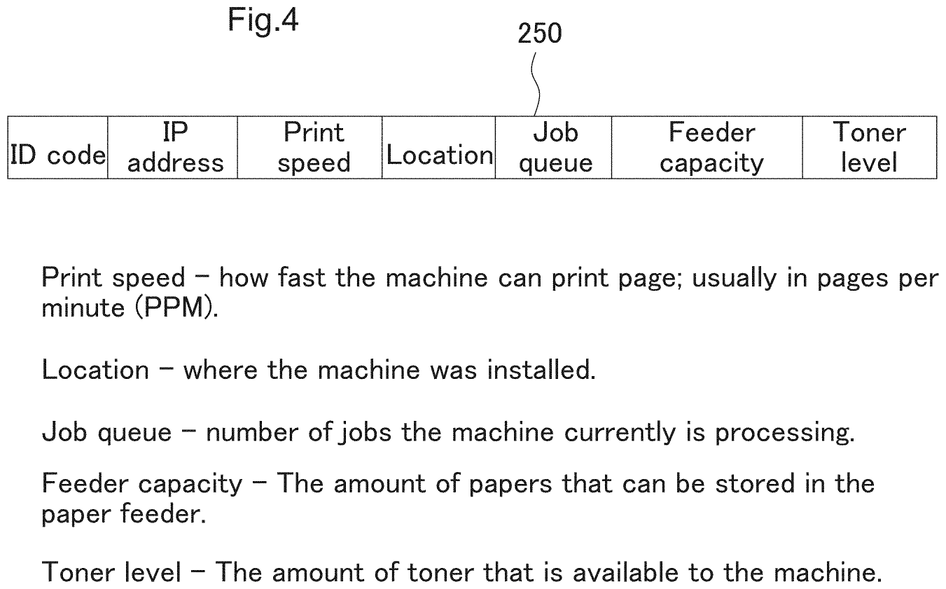

FIG. 4 illustrates an example of a data structure in the apparatus information storage region 250. In the apparatus information storage region 250, information indicating the IP address, print speed, location, job queue, feeder capacity, and toner level, is stored as apparatus information, in association with an ID code for identifying each of the image forming apparatuses 1A to 1E.

The print speed is expressed by the number of sheets that the image forming apparatus 1 (“machine” in FIG. 4) can print in one minute (pages per minute (PPM)). The location refers to the location where the image forming apparatus 1 is installed. The job queue refers to the number of print jobs that the image forming apparatus 1 is currently executing. The feeder capacity refers to the number of recording sheets that can be stored in the paper feeding device 14 of the image forming apparatus 1. Here, although the number of sheets that can be stored is adopted as the feeder capacity in this embodiment, the number of recording sheets actually stored in the paper feeding device 14 of the image forming apparatus 1 may be adopted instead. The toner level refers to the amount of the toner remaining in the image forming apparatus 1.

The apparatus information about the image forming apparatus 1 is transmitted therefrom to the information processing apparatus 2. The controller 210 stores the apparatus information received from the image forming apparatus 1 in the apparatus information storage region 250, in association with the ID code.

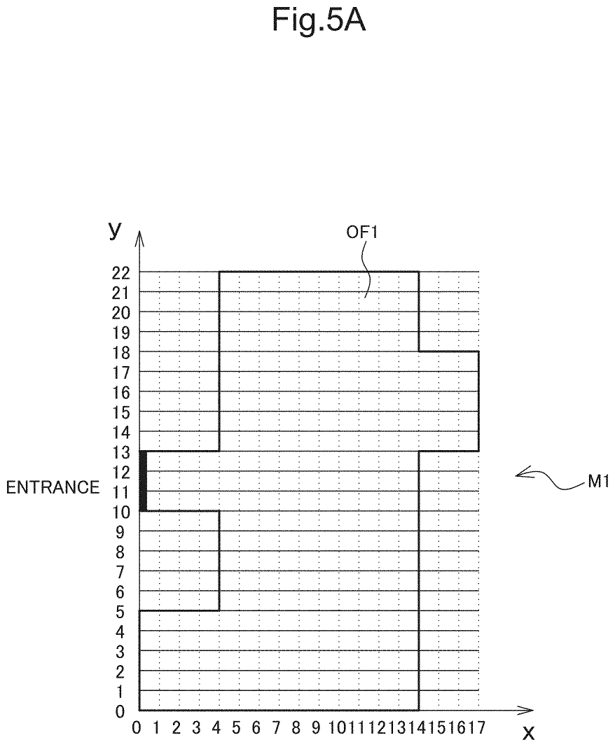

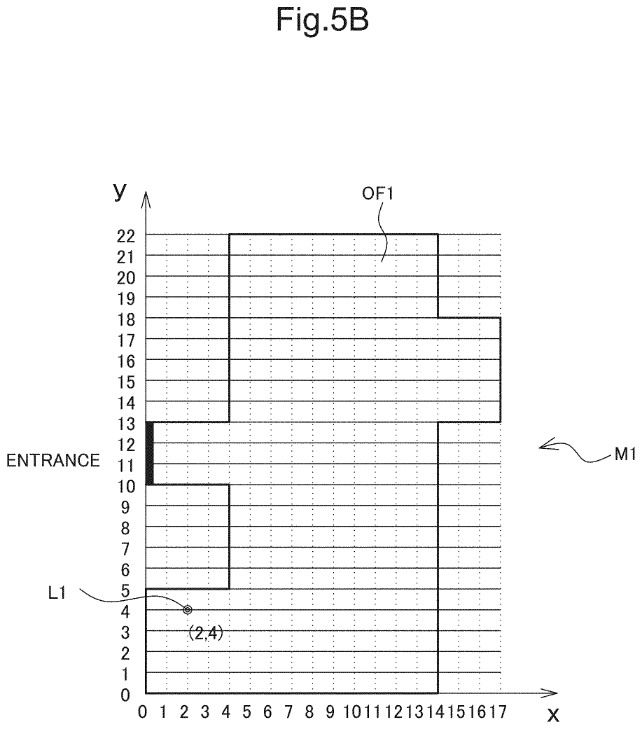

Hereunder, the setting of the location of the image forming apparatus 1 will be described. FIG. 5A illustrates a map Ml, created by mapping the entirety of an office OF1 where the image forming apparatus 1 is installed, on a two-dimensional plane. The map M1 includes an x-coordinate representing the horizontal axis, and a y-coordinate representing the vertical axis.

The storage device 8 of the image forming apparatus 1 contains the map M1 created in advance, as shown in FIG. 5A. The controller 100 of the image forming apparatus 1 causes the display device 473 to display the map M1 stored in the storage device 8, and receives the user's indication of the location of the image forming apparatus 1, through the operation device 47.

FIG. 5B illustrates the map M1 on which the location L1 of the image forming apparatus 1 has been indicated by the user. In this case, the image forming apparatus 1 installed at the location L1 corresponding to the coordinate (2, 4). The controller 100 of the image forming apparatus 1 stores the coordinate information in the storage device 8, as information indicating the location L1 of the image forming apparatus 1.

The control device 21 includes a processor, a RAM, a ROM, and an exclusive hardware circuit. The processor is, for example, a CPU, an ASIC, or an MPU.

The control device 21 acts as a controller 210 and a calculator 211, when the processor operates according to a control program stored in the storage device 25. Here, the controller 210 and the calculator 211 may each be constituted in the form of a hardware circuit, instead of being realized by the operation of the control device 21 according to the control program. This also applies to other embodiments, unless otherwise specifically noted.

The controller 210 serves to control the overall operation of the information processing apparatus 2. The controller 210 is connected to the operation device 22, the display device 23, the communication device 24, and the storage device 25, and controls the operation of the mentioned components.

For example, the controller 210 receives a user's selection of the image forming apparatus 1 to be caused to execute the print job, through the operation device 22, and transmits, upon receipt of an instruction to execute the print job, the print job to the image forming apparatus 1 selected by the user, via the communication device 24.

Upon receipt of the print job transmitted from the information processing apparatus 2, the controller 100 of the image forming apparatus 1 controls the image forming device 12 and the related components so as to form an image on the recording sheet, according to the print job received.

The calculator 211 calculates an evaluation value V for each of one or a plurality of evaluation items designated by the user through the operation device 22, with respect to each of the image forming apparatuses 1A to 1E, and then calculates the sum of the evaluation values V calculated as above, as use priority P of each of the image forming apparatuses 1A to 1E.

The calculator 211 also multiplies the evaluation value V by a weighting coefficient W specified in advance with respect to each of the evaluation items, thereby calculating the weighted value of the evaluation value V. The weighting coefficient W is specified in advance, according to the user's instruction inputted through the operation device 22.

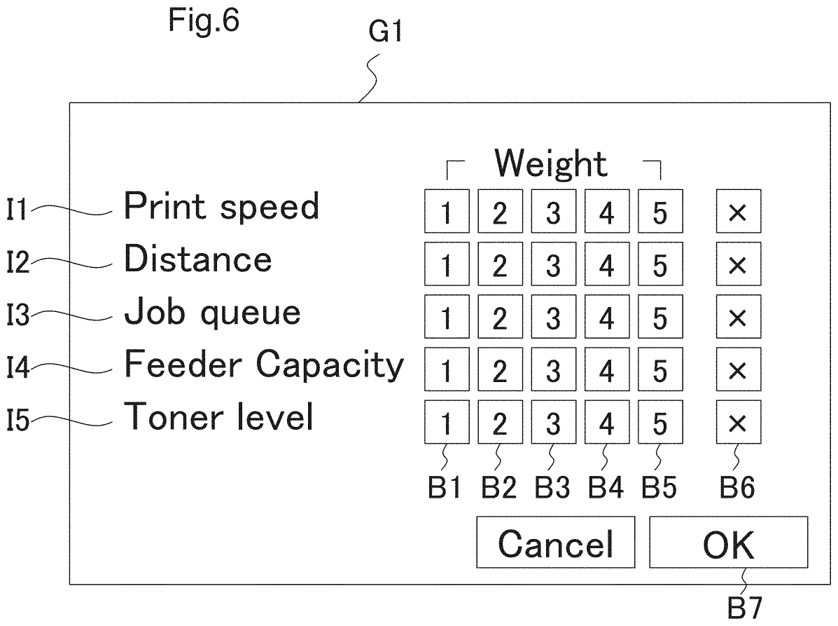

The evaluation items include at least one of the print speed of the image forming apparatus 1 (Print speed in FIG. 6), a distance between the information processing apparatus 2 and the image forming apparatus 1 (Distance), the number of print jobs that the image forming apparatus 1 is scheduled to execute (Job queue), the number of recording sheets that can be stored in the image forming apparatus 1 (Feeder capacity), and a residual amount of a consumable (in this case, the toner) used in the image forming apparatus 1 (Toner level). This embodiment represents the case where all the evaluation items cited above are adopted. Here, the recording sheet may be adopted as the consumable, instead of the toner or ink used for the image forming operation by the image forming apparatus 1.

FIG. 6 illustrates an example of an operation screen for the user to input selection of the evaluation items to be used for the calculation of the use priority P The controller 210 causes the display device 23 to display the operation screen G1, including five evaluation items I1 to I5 (hereinafter collectively “evaluation item I” where appropriate) aligned in the vertical direction, selection buttons B1 to B5 corresponding to each of the evaluation items I, and each corresponding to one of five values from “1” to “5” indicating the importance (Weight), and corresponding to the weighting coefficient W, a selection button B6 marked as “x” for invalidating the evaluation item I, and a selection button B7 marked as “OK”. The controller 210 receives, through the touch panel, the instruction corresponding to the selection button displayed at the position touched by the user. The controller 210 causes the display device 23 to display the selection buttons corresponding to the instruction received, in a different display mode (e.g., in a different color), from the remaining selection buttons.

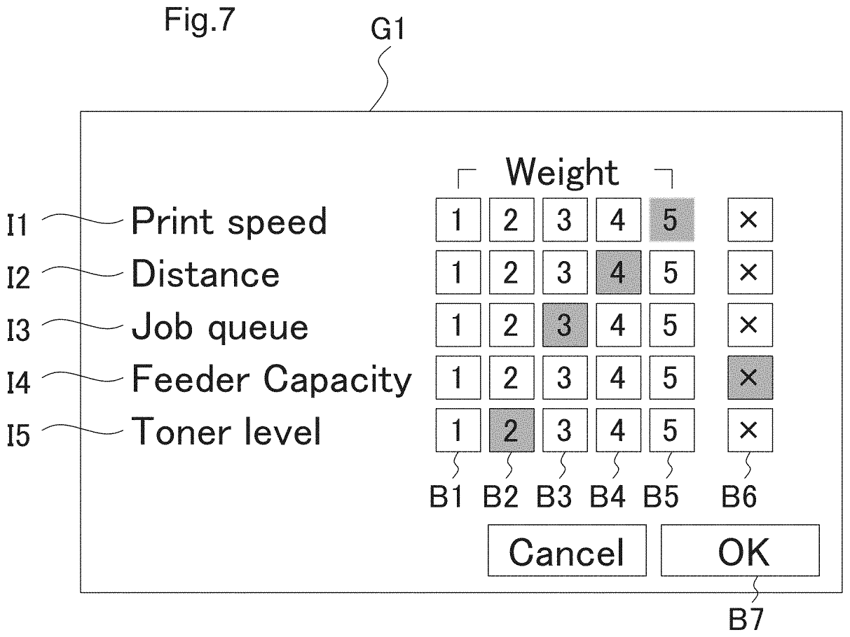

When the operation device 22 receives the user's operation performed on the selection button B7 marked as “OK”, after the user selected the selection buttons B1 to B6 as shown in FIG. 7, the controller 210 sets the weight of the evaluation items I1 to 15 to 5, 4, 3, 0, and 2, respectively, and stores such weights in the storage device 25, as weighting coefficient W. Here, the controller 210 sets the weight of the evaluation item I4 to “0”, because the user selected the selection button B6 for the evaluation item I4, thus invalidating this item. Further, the operation device 22 accepts the user's touch on the selection button B7, only when the instruction indicating the weight is inputted, with respect to all of the evaluation items I1 to IS.

The information processing apparatus 2 possesses a “preference print” function, newly proposed in this embodiment. The controller 210 validates or invalidates the “preference print” function, according to the user's instruction inputted through the operation device 22.

Upon receipt of an instruction to execute the print job through the operation device 22, under the state where the “preference print” function is set valid, the controller 210 requests the image forming apparatus 1 to transmit predetermined apparatus information, through the communication device 24. The controller 210 updates the apparatus information storage region 250, according to the apparatus information transmitted from the image forming apparatus 1, in response to the request.

The calculator 211 calculates distance D between the information processing apparatus 2 and the image forming apparatus 1, on the basis of the information indicating the location of the image forming apparatus 1, stored in the apparatus information storage region 250, and the information indicating the location of the information processing apparatus 2, stored in advance.

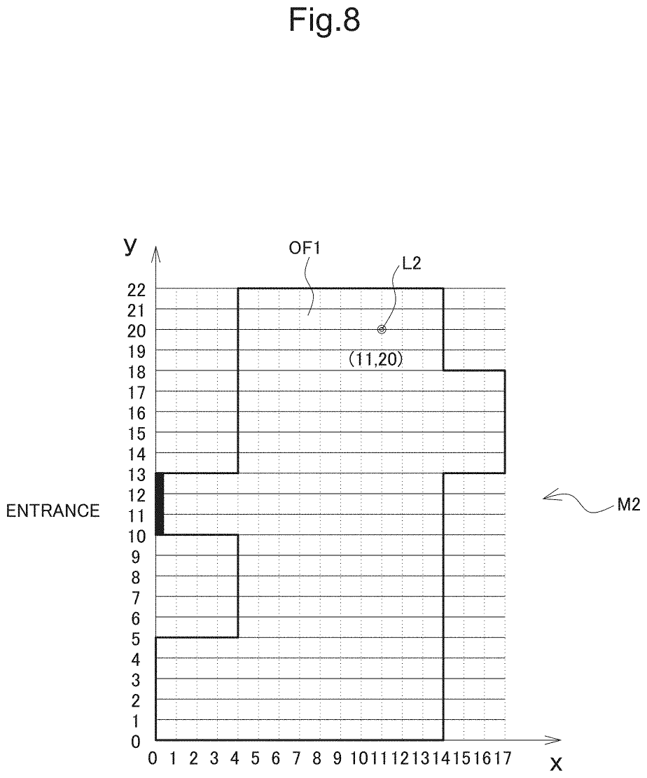

The storage device 25 contains, like the image forming apparatus 1, a map M2 indicating the location L2 of the information processing apparatus 2, as shown in FIG. 8. In this example, the coordinate of the location L2 is (11, 20). The calculator 211 calculates the distance D, using such information. In this case, the calculator 211 calculates the distance D between the image forming apparatus 1 located at the coordinate (2, 4) and the information processing apparatus 2 located at the coordinate (11, 20), as approximately 18.36, on the basis of Pythagorean theorem.

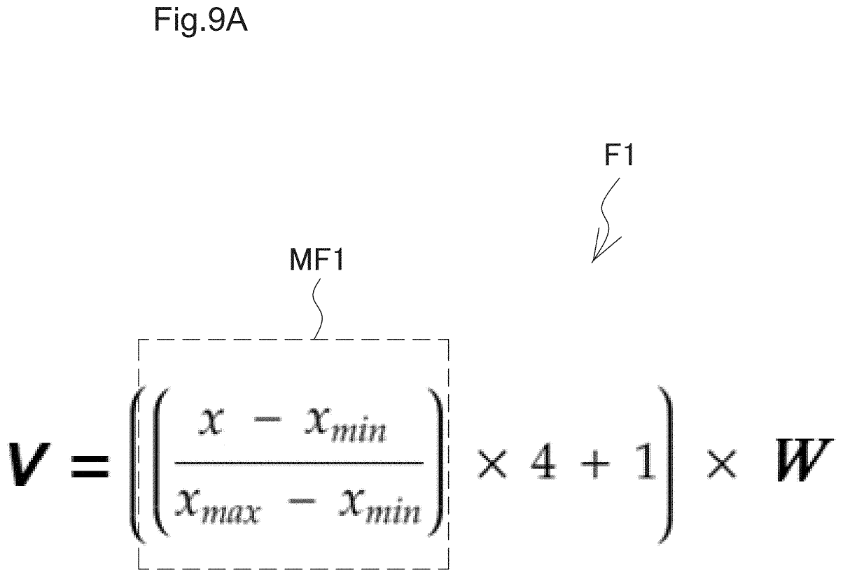

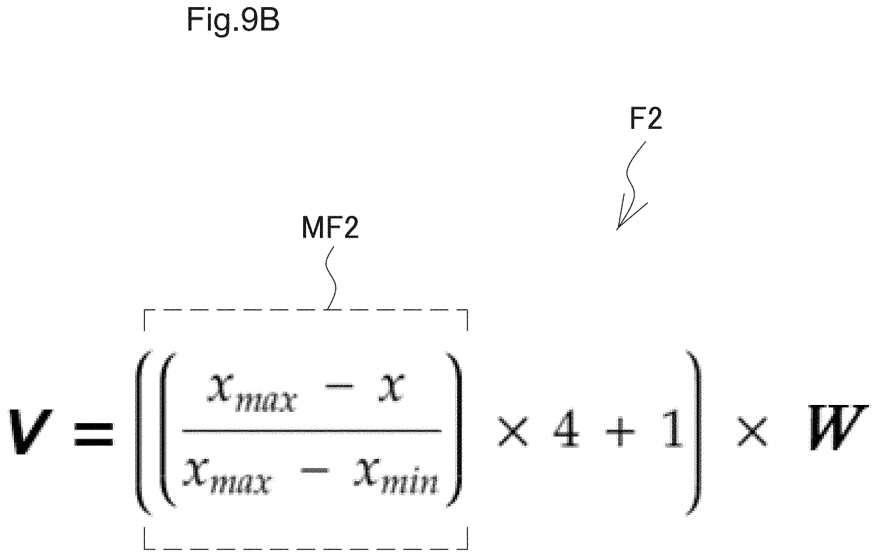

Then the calculator 211 calculates the evaluation value V for each of the evaluation items designated by the user, using equations F1 and F2 respectively shown in FIG. 9A and FIG. 9B. The evaluation value V represents a relative value among the image forming apparatuses 1A to 1E. The calculator 211 uses the equation F1 shown in FIG. 9A, for the evaluation items that gain higher evaluation the larger the numerical value is (i.e., print speed, the number of recording sheets that can be stored, and toner level). In contrast, the calculator 211 uses the equation F2 shown in FIG. 9B, for the evaluation items that gain higher evaluation the smaller the numerical value is (i.e., distance and job queue).

In the equations F1 and F2, Xmax represents the maximum value among all the image forming apparatuses 1A to 1E, and Xmin represents the minimum value among all the image forming apparatuses 1A to 1E. The calculator 211 calculates the relative evaluation among the image forming apparatuses 1A to 1E (expressed as a point between 0 and 1), using fractional expressions MF1 and MF2 enclosed in broken lines.

For example, when the print speed (pages/min) of the image forming apparatuses 1A to 1E is “70”, “40”, “20”, “25”, and “50”, respectively, the calculator 211 sets the Xmax to “70”, and Xmin to “20”. Since the higher evaluation is given to the larger numerical value for the evaluation item I1 “print speed (Print speed)”, the calculator 211 uses the equation Fl to calculate the relative evaluation for the evaluation item I1. In the case of this example, the calculator 211 calculates the relative evaluation for the evaluation item I1 with respect to the image forming apparatuses 1A to 1E, as “1”, “0.4”, “0”, “0.1”, and “0.6”, respectively.

When the number of job queues of the image forming apparatuses 1A to 1E is “8”, “4”, “2”, “0”, and “1”, respectively, the calculator 211 sets the Xmax to “8”, and Xmin to “0”. Since the higher evaluation is given to the smaller numerical value for the evaluation item 13 “Job queue”, the calculator 211 uses the equation F2 to calculate the relative evaluation for the evaluation item 13. In the case of this example, the calculator 211 calculates the relative evaluation for the evaluation item 13 with respect to the image forming apparatuses 1Ato 1E, as “0”, “0.5”, “0.75”, “1”, and “0.875”, respectively.

When calculating the weighted evaluation value V, by multiplying the relative evaluation (evaluation value) by the weighting coefficient W, specified for each of the evaluation items I, the calculator 211 multiplies, instead of the relative evaluation as it is, a value obtained by expanding the range of the relative evaluation, by the weighting coefficient W. As a specific example, the calculator 211 multiplies the relative evaluation obtained through the fractional expressions MF1 and MF2 by 4, and further adds 1, as shown in the equations F1 and F2. Therefore, the range of the relative evaluation is expanded from “0 to 1” to “1 to 5”. As result, the effect of the weighting can be more prominently reflected.

The calculator 211 then calculates the sum of the evaluation values V obtained through the equations F1 and F2 (evaluation values V for each of the evaluation items I designated by the user), thereby determining the use priority P of each of the image forming apparatuses 1Ato 1E.

The controller 210 transmits the print job, the execution of which has been instructed by the user through the operation device 22, to the image forming apparatus 1 that has gained the highest use priority P provided by the calculator 211, through the communication device 24.

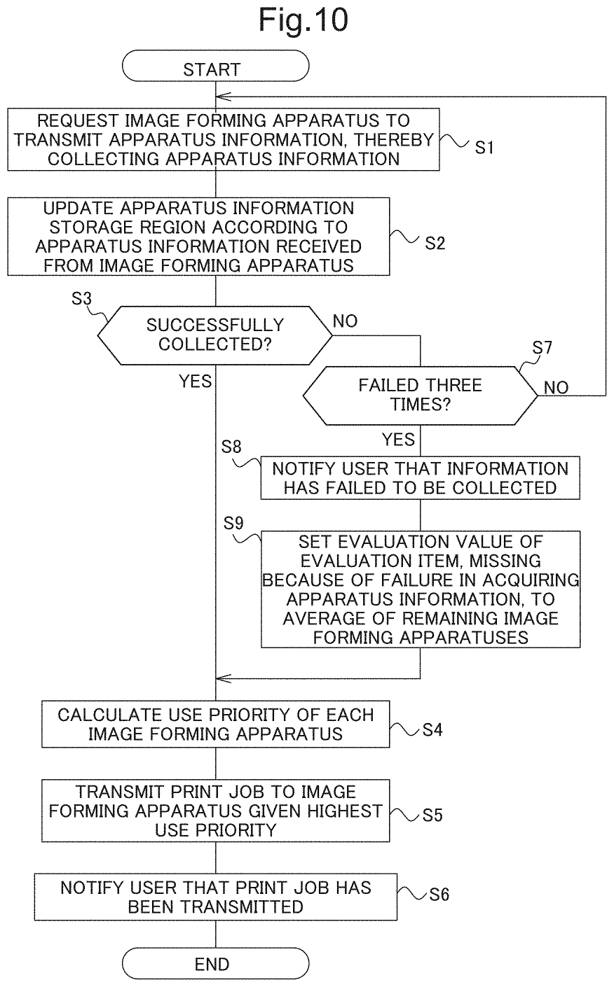

Referring now to a flowchart shown in FIG. 10, description will be given regarding a priority calculation process executed by the control device 21, when the user instructs to execute the print job through the operation device 22, under the state where the “preference print” function is valid.

The controller 210 collects the apparatus information (step S1), by requesting the image forming apparatus 1 to transmit the predetermined apparatus information, through the communication device 24, and receiving the apparatus information from each of the image forming apparatuses 1A to 1E. The controller 210 then updates the apparatus information storage region 250 according to the apparatus information received from the image forming apparatus 1 in response to the request (step S2).

Then the controller 210 decides whether the apparatus information of the image forming apparatus 1 has been successfully collected (step S3). Here, the term “success” refers to the case where the information processing apparatus 2 has received the values of all the evaluation items, as the apparatus information, from each of the image forming apparatuses 1A to 1E. On the other hand, the term “failure” refers to the case where, although the information processing apparatus 2 has received the apparatus information from each of the image forming apparatuses 1A to 1E, one or more evaluation values are missing.

When the controller 210 decides that the information has been successfully collected (YES at step S3), the calculator 211 calculates the use priority P with respect to each of the image forming apparatuses 1A to 1E (step S4). The controller 210 transmits, through the communication device 24, the print job, the execution of which has been instructed by the user through the operation device 22, to the image forming apparatus 1 to which the calculator 211 has given the highest use priority P (step S5). After step S5, the controller 210 causes the display device 23 to display information indicating that the print job has been transmitted, and also indicating the transmission destination of the print job (step S6). Accordingly, the user can be made aware of the mentioned information. After step S6, the controller 210 finishes the priority calculation process.

Upon deciding, in contrast, that the apparatus information of the image forming apparatus 1 has failed to be collected (NO at step S3), the controller 210 decides whether the failure has been committed a predetermined number of times (e.g., three times) (step S7). Upon deciding that the number of times of failure is fewer than three (NO at step S7), the controller 210 again requests the image forming apparatus 1 to transmit the apparatus information (step S1).

On the other hand, upon deciding that the number of times of failure has reached three (YES at step S7), the controller 210 causes the display device 23 to display information indicating that the apparatus information has failed to be collected (step S8). Accordingly, the user can be made aware of the mentioned information. In this case, the calculator 211 sets the evaluation value for the evaluation item, which is missing because of the apparatus information having failed to be acquired, to the average of the evaluation values for the corresponding evaluation item of the remaining image forming apparatuses (step S9), to thereby calculate the use priority P with respect to each of the image forming apparatuses 1A to 1E (step S4).

Now, although the arrangement to select the printer that can complete the print job in the shortest time, as the aforementioned first technique and the third technique, is very useful, such an arrangement may not necessarily satisfy the users. For example, although the print job can be finished in a short time, the degree of user satisfaction is not sufficiently high, when that printer is located distant from the user.

In addition, the foregoing second technique, including transferring the print job from the printer unable to execute the print job, to the printer that can execute the print job, can be beneficial to the user. However, the print job may be transferred to a printer located distant from the user, in which case the user will not be fully satisfied.

According to the foregoing embodiment, in contrast, the use priority P of the image forming apparatus 1 is calculated, on the basis of the evaluation value of one or a plurality of evaluation items designated by the user (e.g., print speed of the image forming apparatus 1, distance to the image forming apparatus 1, and so forth), and the print job is transmitted to the image forming apparatus 1 that has gained the highest use priority P In other words, the print job is executed by the image forming apparatus 1 that has gained the highest use priority P

Since the user can designate the evaluation item I to be used for the calculation of the use priority P, the image forming apparatus 1 desirable to the user, in other words the image forming apparatus that realizes an optimum performance defined by the user, can be made to execute the print job, unlike the first to third techniques of simply selecting the image forming apparatus 1 that finishes the print job promptly. Therefore, the image forming apparatus 1 that is optimum to the user for executing the print job can be selected, which leads to higher degree of user satisfaction.

The disclosure may be modified in various manners, without limitation to the configuration according to the foregoing embodiments. Further, the configurations and processings according to the foregoing embodiments, described with reference to FIG. 1 to FIG. 10, are merely exemplary and in no way intended to limit the disclosure to those configurations and processings.

While the present disclosure has been described in detail with reference to the embodiments thereof, it would be apparent to those skilled in the art the various changes and modifications may be made therein within the scope defined by the appended claims.

What is claimed is;:

1. An information processing apparatus comprising:
an operation device that receives an instruction according to an operation performed by a user;
a communication device that performs data communication with a plurality of image forming apparatuses; and
a control device including a processor, and configured to act, when the processor executes a control program, as
a calculator that calculates an evaluation value for each of one or more evaluation items designated by the user through the operation device and calculates a sum of the calculated evaluation values, as use priority, with respect to each of the plurality of image forming apparatuses; and
a controller that transmits a print job, execution of which has been instructed by the user through the operation device, to the image forming apparatus that has gained highest user priority, via the communication device.

2. The information processing apparatus according to claim 1,
wherein, upon receipt of the instruction to execute the print job through the operation device, the controller collects, through the communication device, predetermined apparatus information about the one or more evaluation items from each of the plurality of image forming apparatuses, and
the calculator calculates the evaluation value on a basis of the apparatus information.

3. The information processing apparatus according to claim 1,
wherein the controller calculates the evaluation value for each of the one or more evaluation items, including at least one of print speed, a distance between the information processing apparatus and the image forming apparatus, a number of print jobs that the image forming apparatus is scheduled to execute, a number of recording sheets that can be stored, and a residual amount of a consumable.

4. The information processing apparatus according to claim 1,
wherein the calculator calculates a weighted value of the evaluation value, by multiplying the evaluation value by a weighting coefficient determined in advance with respect to each of the evaluation items, and
the controller sets the weighting coefficient in advance, according to the instruction of the user inputted through the operation device.

5. The information processing apparatus according to claim 1,
wherein the calculator calculates, as the evaluation value, a relative evaluation value among the plurality of image forming apparatuses.

6. The information processing apparatus according to claim 5,
wherein the calculator calculates a point in a range between 0 and 1, as the relative evaluation value, and calculates a weighted value of the evaluation value by multiplying a value corresponding to the relative evaluation value, obtained by expanding the range of the relative evaluation, by the weighting coefficient.

7. The information processing apparatus according to claim 2,
wherein, when the apparatus information about one or more of the evaluation items is unable to be acquired from one of the plurality of image forming apparatus, the calculator calculates an average of the evaluation value for the corresponding evaluation item of other ones of the plurality of image forming apparatuses, as the evaluation value for the evaluation item of the one image forming apparatus.

8. A print control method to be executed by an information processing apparatus including an operation device that receives an instruction according to an operation performed by a user, and a communication device that performs data communication with a plurality of image forming apparatuses, the method comprising:
calculating an evaluation value for each of one or more evaluation items designated by the user through the operation device and calculating a sum of the calculated evaluation values, as use priority, with respect to each of the plurality of image forming apparatuses; and
transmitting a print job, execution of which has been instructed by the user through the operation device, to the image forming apparatus that has gained highest user priority, via the communication device.
